(19) United States
(12) Patent Application Publication
(10) Pub. No.: US 2016/0125363 A1
(43) Pub. Date: May 5, 2016

(54) ATTENDANCE SYSTEM AND METHOD

(71) Applicants: HONG FU JIN INDUSTRY (WuHan) Co., LTD., Wuhan (CN); HON HAI PRECISION INDUSTRY CO., LTD., New Taipei (TW)

(72) Inventors: JIAN-HUNG HUNG, New Taipei (TW); NUO-LIN MENG, Wuhan (CN)

(21) Appl. No.: 14/575,186

(22) Filed: Dec. 18, 2014

(30) Foreign Application Priority Data
Oct. 31, 2014 (CN) 201410600071.5

(51) Int. Cl. G06Q 10/10; H04W 4/00

(52) U.S. Cl. CPC G06Q 10/1091; H04W 4/008

(57) ABSTRACT

An attendance method and system are disclosed. A user device sends identifying information to an attendance device. The attendance device correlates the identifying information with a current time and produces an attendance record using the identifying information and the current time. The attendance device packages the attendance record into a data packet and transmits the data packet to the user device. The user device stores the data packet in a non-volatile memory of the user device.

### CROSS-REFERENCE TO RELATED APPLICATIONS

This application claims priority to Chinese Patent Application No. 201410600071.5 filed on Oct. 31, 2014, the contents of which are hereby incorporated by reference.

### FIELD

The subject matter herein generally relates to data recording, and more particularly relates to systems and methods for recording the attendance of persons.

### BACKGROUND

It is common practice for employees to “clock in” and “clock out” when checking in and out of work, such as when arriving at work, taking a lunch break and leaving for the day. The use of time clocks for tracking employee attendance and duties is commonplace. The employee can clock in and clock out by means of a code inputted into an attendance device either manually or by means of a swipe card or the like. Time and attendance records can be retrieved from the attendance device in a variety of ways. However, the attendance device is susceptible to data loss and sometimes cannot provide the time and attendance records for some reason, such as being damaged.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a block diagram of an embodiment of an attendance system.

FIG. 2 is a flowchart of a first embodiment of an attendance method.

FIG. 3 is a flowchart of a second embodiment of an attendance method.

FIG. 4 is a flowchart of a third embodiment of an attendance method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references can mean “at least one.”

The term “comprising” means “including, but not necessarily limited to”; it specifically indicates open-ended inclusion or membership in a so-described combination, group, series and the like.

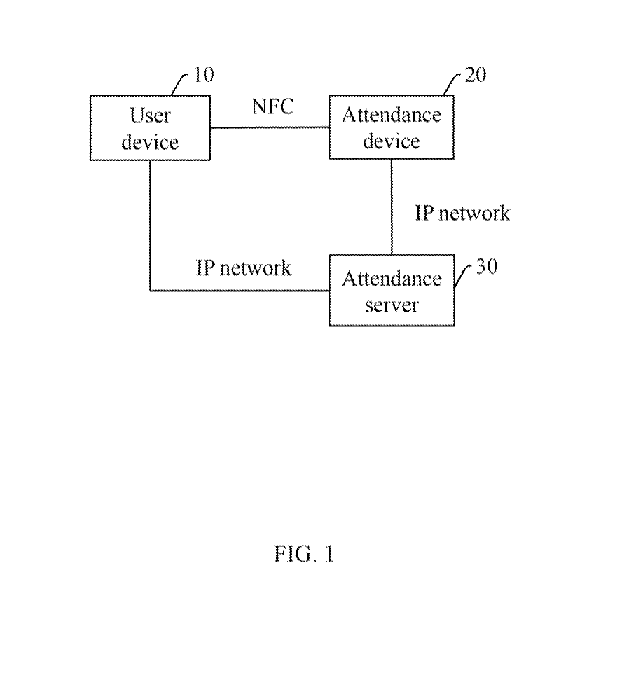

FIG. 1 illustrates an embodiment of an attendance system. The attendance system can include a user device 10, an attendance device 20, and an attendance server 30. The attendance system can record the attendance of persons, such as employees.

The user device 10 can send identifying information to the attendance device 20. The identifying information can be used to identify a person of an organization, such as an employee of a company. The identifying information can include an identification number for identifying a person. In some embodiments, the identifying information can include a device unique identifier code for identifying the user device 10 which is correlated with a person. The user device 10 can be a smart phone, a tablet PC, a personal digital assistant (PDA), a media player, a gaming device, or any other type of electronic device.

When the attendance device 20 receives the identifying information from the user device 10, the attendance device 20 can correlate the identifying information with a current time and produce an attendance record using the identifying information and the current time. The attendance device 20 can be installed at an entrance of a company.

The attendance device 20 can send the attendance record to the attendance server 30. When the attendance server 30 receives the attendance record, the attendance server 30 can store the attendance record in a storage unit of the attendance server 30.

In some embodiments, the attendance device 20 can package the attendance record into a data packet and transmit the data packet to the user device 10. When the user device 10 receives the data packet, the user device 10 can store the data packet in a non-volatile memory of the user device 10.

When the attendance device 20 cannot transmit the attendance record to the attendance server 30 for some reason, the user device 10 can be connected to the attendance server 30 and transmit the data packet to the attendance server 30. When the attendance server 30 receives the data packet, the attendance server 30 can retrieve the attendance record from the data packet and store the attendance record in the storage unit of the attendance server 30.

In some embodiments, the user device 10 can establish a near filed communication (NFC) connection to the attendance device 20. The user device 10 and the attendance device 20 can exchange data via the NFC connection. Specifically, the user device 10 can send the identifying information to the attendance device 20 via the NFC connection, and the attendance device 20 can send the data packet to the user device 10 via the NFC connection. In other embodiments, the user device 10 and the attendance device 20 can exchange data via a USB connection, an infrared connection, a BLUETOOTH® connection, or a Wi-Fi Direct connection.

The attendance device 20 can be connected to the attendance server 30 via an Internet Protocol (IP) network. The attendance device 20 and the attendance server 30 can exchange data via the IP network. Specifically, the attendance device 20 can send the attendance record to the attendance server 30 via the IP network.

In some embodiments, the user device 10 can be connected to the attendance server 30 via an IP network can send the data packet to the attendance server 30 via the IP network. In other embodiments, the user device 10 can be connected to the attendance server via a USB connection, an infrared connection, a BLUETOOTH® connection, or a Wi-Fi Direct connection.

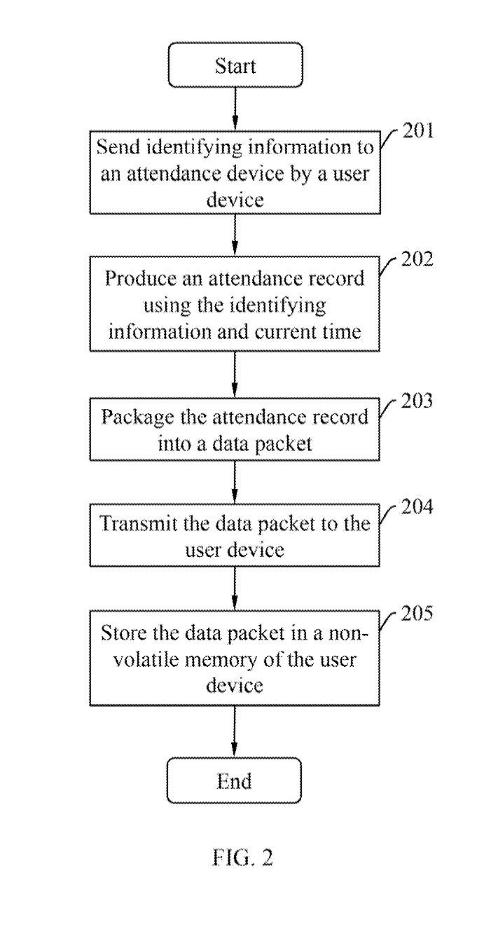

Referring to FIG. 2, a flowchart of an attendance method is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods or subroutines, carried out in the exemplary method. Additionally, the illustrated order of blocks is by example only and the order of the blocks can change according to the present disclosure. The exemplary method can begin at block 201.

At block 201, a user device 10 sends identifying information to an attendance device 20. The identifying information is used to identify a person of an organization, such as an employee of a company.

At block 202, the attendance device 20 correlates the identifying information with a current time and produces an attendance record using the identifying information and the current time.

At block 203, the attendance device 20 packages the attendance record into a data packet.

At block 204, the attendance device 20 transmits the data packet to the user device 10.

At block 205, the user device 10 stores the data packet in a non-volatile memory of the user device 10.

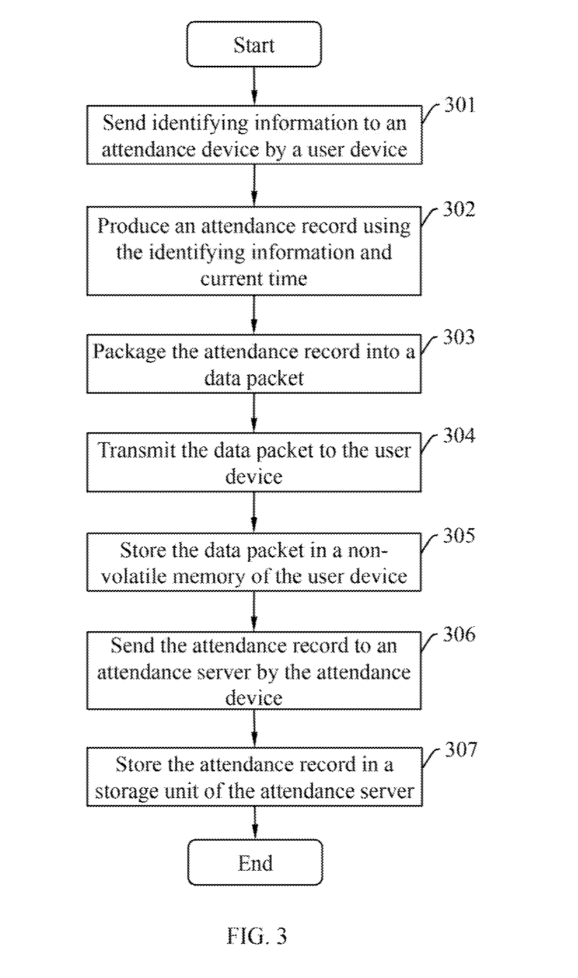

FIG. 3 shows a flowchart of a second embodiment of an attendance method is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods or subroutines, carried out in the exemplary method. Additionally, the illustrated order of blocks is by example only and the order of the blocks can change according to the present disclosure. The exemplary method can begin at block 301.

At block 301, a user device 10 sends identifying information to an attendance device 20. The identifying information is used to identify a person of an organization, such as an employee of a company.

At block 302, the attendance device 20 correlates the identifying information with a current time and produces an attendance record using the identifying information and the current time.

At block 303, the attendance device 20 packages the attendance record into a data packet.

At block 304, the attendance device 20 transmits the data packet to the user device 10.

At block 305, the user device 10 stores the data packet in a non-volatile memory of the user device 10.

At block 306, the attendance device 20 sends the attendance record to an attendance server 30.

At block 307, the attendance server 30 stores the attendance record in a storage unit of the attendance server 30.

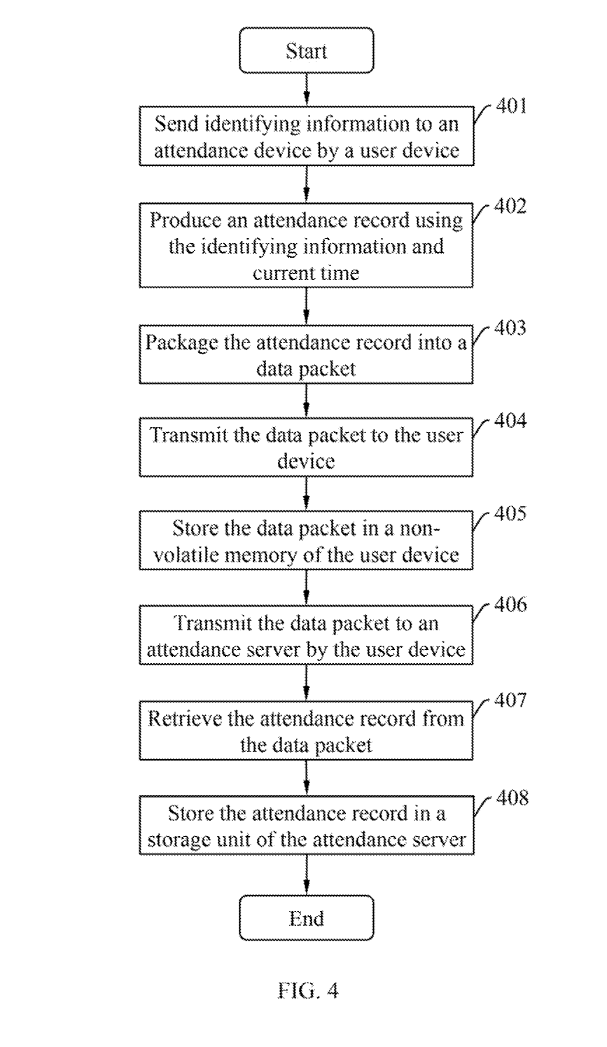

FIG. 4 shows a flowchart of a third embodiment of an attendance method is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining the example method. Each block shown in FIG. 4 represents one or more processes, methods or subroutines, carried out in the exemplary method. Additionally, the illustrated order of blocks is by example only and the order of the blocks can change according to the present disclosure. The exemplary method can begin at block 401.

At block 401, a user device 10 sends identifying information to an attendance device 20. The identifying information is used to identify a person of an organization, such as an employee of a company.

At block 402, the attendance device 20 correlates the identifying information with a current time and produces an attendance record using the identifying information and the current time.

At block 403, the attendance device 20 packages the attendance record into a data packet.

At block 404, the attendance device 20 transmits the data packet to the user device 10.

At block 405, the user device 10 stores the data packet in a non-volatile memory of the user device 10.

At block 406, the user device 10 is connected to an attendance server 30 and transmits the data packet to the attendance server 30.

At block 407, the attendance server 30 retrieves the attendance record from the data packet.

At block 408, the attendance server 30 stores the attendance record in a storage unit of the attendance server 30.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. An attendance method comprising:
sending identifying information to an attendance device by a user device;
correlating the identifying information with a current time by the attendance device;
producing an attendance record using the identifying information and the current time by the attendance device;
packaging the attendance record into a data packet by the attendance device;
transmitting the data packet to the user device by the attendance device; and
storing the data packet in a non-volatile memory of the user device.

2. The attendance method of claim 1, further comprising:
transmitting the attendance record to an attendance server by the attendance device; and
storing the attendance record in a storage unit of the attendance server.

3. The attendance method of claim 2, wherein the attendance device transmits the attendance record to the attendance server via an Internet Protocol (IP) network.

4. The attendance method of claim 1, further comprising:
sending the data packet to an attendance server by the user device;
retrieving the attendance record from the data packet by the attendance server; and
storing the attendance record in a storage unit of the attendance server.

5. The attendance method of claim 1, wherein the user device sends the data packet to an attendance server via an IP network.

6. The attendance method of claim 1, wherein the user device sends the data packet to an attendance server via a USB connection.

7. The attendance method of claim 1, wherein the user device sends the identifying information to the attendance device via a near field communication (NFC) connection.

8. The attendance method of claim 7, wherein the attendance device transmits the data packet to the user device via the NFC connection.

9. The attendance method of claim 1, wherein the identifying information comprises a device unique identifier code for identifying the user device.

10. The attendance method of claim 1, wherein the identifying information comprises an identification number for identifying a person.

11. An attendance system comprising:
a user device; and
an attendance device;
wherein the user device is configured to send identifying information to the attendance device; the attendance device is configured to correlate the identifying information with a current time, produce an attendance record using the identifying information and the current time, packaging the attendance record into a data packet, and transmit the data packet to the user device; the user device is configured to store the data packet in a non-volatile memory of the user device.

12. The attendance system of claim 11, further comprising an attendance server, wherein the attendance device is further configured to transmit the attendance record to the attendance server, and the attendance server is configured to store the attendance record in a storage unit of the attendance server.

13. The attendance system of claim 12, wherein the attendance device is configured to transmit the attendance record to the attendance server via an Internet Protocol (IP) network.

14. The attendance system of claim 11, further comprising an attendance server, wherein the user device is further configured to send the data packet to the attendance server, and the attendance server is configured to retrieve the attendance record from the data packet and store the attendance record in a storage unit of the attendance server.

15. The attendance system of claim 11, wherein the user device is configured to send the data packet to an attendance server via an IP network.

16. The attendance system of claim 11, wherein the user device is configured to send the data packet to an attendance server via a USB connection.

17. The attendance system of claim 11, wherein the user device is configured to send the identifying information to the attendance device via a near field communication (NFC) connection.

18. The attendance system of claim 17, wherein the attendance device is configured to transmit the data packet to the user device via the NFC connection.

19. The attendance system of claim 11, wherein the identifying information comprises a device unique identifier code for identifying the user device.

20. The attendance system of claim 11, wherein the identifying information comprises an identification number for identifying a person.
